(19) United States
(12) Patent Application Publication
(10) Pub. No.: US 2024/0266933 A1
(43) Pub. Date: Aug. 8, 2024

(54) ROTOR FOR SYNCHRONOUS ELECTRIC MACHINE

(71) Applicant: FORD GLOBAL TECHNOLOGIES, LLC

(72) Inventors: Wei Wu, Northville, MI (US); Dexiang Dallis Sun, Troy, MI (US); Devan James Anderson, Taylor, MI (US)

(21) Appl. No.: 18/163,385

(22) Filed: Feb. 2, 2023

(51) Int. Cl. H02K 21/14; H02K 7/00; H02K 15/03

(52) U.S. Cl. CPC H02K 21/14; H02K 7/003; H02K 15/03

(57) ABSTRACT

A permanent magnet synchronous motor includes a shaft with an integrally formed flange and resolver rotor. The resolver rotor is formed by machining a set of cutouts in the flange. The rotor body, which includes the permanent magnets, is assembled onto the shaft from the end of the shaft opposite the flange and resolver rotor. Features, such as keyways on the shaft and keys on the rotor body establish a rotational position relationship between the shaft and the permanent magnets.

### TECHNICAL FIELD

The present disclosure relates to electric motor construction. More particularly, the disclosure pertains to the structure and corresponding method of assembly of a permanent magnet synchronous motor having a rotor shaft with an integral resolver rotor.

### BACKGROUND

Vehicles such as battery-electric vehicles and hybrid-electric vehicles utilize traction motors in addition to or instead of internal combustion engines. A common type of electric traction motor for these applications is a permanent magnet synchronous motor which utilize a three-phase inverter to convert direct current from a high voltage battery to alternating current at a frequency, amplitude, and phase angle calculated to result is a desired motor torque. Determination of the proper phase angle for each of the three alternating current phases requires information about the motor's present rotational position. This position may be determined based on a signal from a resolver.

### SUMMARY

A traction motor includes a stator, a shaft, a rotor body, and a sensor. The shaft is supported for rotation with respect to the stator. The shaft has a fixed flange defining radial cutouts which may be integrally formed with the shaft. An end section of the shaft opposite the flange has a maximum diameter. The shaft may define an axial keyway which may or may not extend through the flange. The rotor body is rotationally fixed to the shaft. The rotor body axially abuts the flange at a first end and axially overlaps the end section at a second end. The rotor body has a set of permanent magnets at predefined circumferential positions with respect to the cutouts. The rotor body has an inside diameter no less than the maximum diameter of the end section such that the shaft can be inserted therein. The rotor body may include an inwardly extending key mating with the keyway to establish a predetermined relative rotational position between the shaft and the rotor body. The sensor is fixed to the stator and produces a signal indicating a rotational position of the shaft with respect to the stator based on the position of the cutouts.

A rotor assembly includes a shaft and a rotor body. The shaft has a fixed flange which may be integrally formed with the shaft. The flange defines radial cutouts which interact with a non-rotating resolver sensor such that the resolver sensor produces a signal indicating a rotational position. The shaft has an end section, opposite the flange, with a maximum diameter. The shaft may define an axial keyway which may or may not extend through the flange. The rotor body is rotationally fixed to the shaft. The rotor body axially abuts the flange at a first end and overlaps the end section at a second end. The rotor body has an inside diameter no less than the maximum diameter of the end section such that the shaft is insertable in the rotor body. A set of permanent magnets may be affixed to the rotor body. The rotor body may include an inwardly extending key mating with the keyway to establish a predetermined relative rotation position between the shaft and the rotor body.

A method of assembling a motor includes forming a plurality of cutouts in a flange of a rotor shaft and inserting a rotor body onto the shaft. The cutouts interact with a non-rotating resolver sensor such that the resolver sensor produces a signal indicating a rotational position of the shaft. The rotor body axially abuts the flange. An axial keyway may be formed on the shaft, which may or may not extend through the flange. A lock nut may be attached to the shaft axially abutting the rotor body on an opposite end of the rotor body from the flange.

### BRIEF DESCRIPTION OF THE DRAWINGS

FIG. 1 is a schematic diagram of a plug-in hybrid electric vehicle.

FIG. 2 is a schematic cross section of a permanent magnet synchronous motor suitable for use in the vehicle of FIG. 1.

FIG. 3 is an end view of a rotor body of the motor of FIG. 2.

FIG. 4 is a partial cross section of a synchronous motor suitable for use in the vehicle of FIG. 1.

FIGS. 5A and 5B are pictorial views of a rotor shaft with a flange suitable for use in the motor of FIG. 4.

FIG. 6 is a flow chart for a method of assembling a rotor of the motor of FIG. 4.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

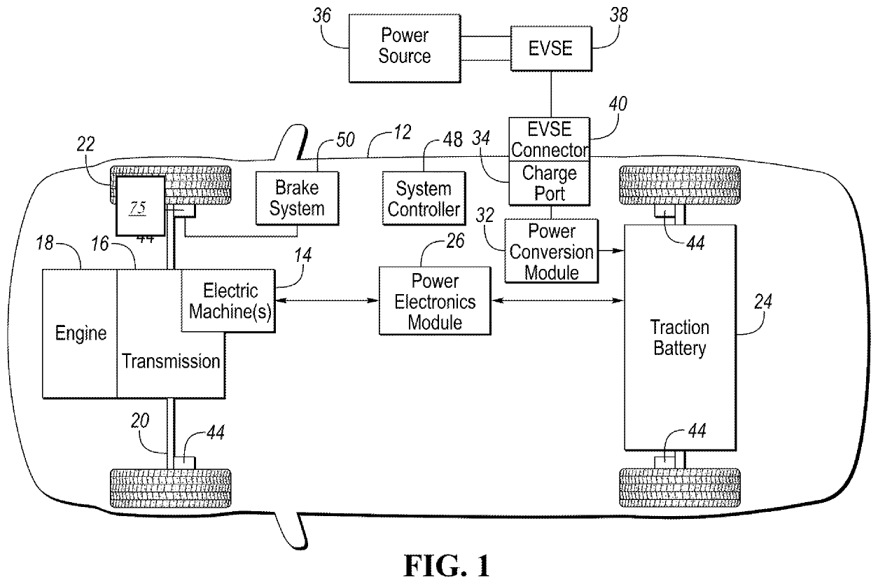

Referring now to FIG. 1, a block diagram of an exemplary electric vehicle (“EV”) 12 is shown. In this example, EV 12 is a plug-in hybrid electric vehicle (PHEV). EV 12 includes one or more electric machines 14 (“e-machines”) mechanically connected to a transmission 16. Electric machine 14 is capable of operating as a motor and as a generator. Transmission 16 is mechanically connected to an engine 18 and to a drive shaft 20 mechanically connected to wheels 22. Electric machine 14 can provide propulsion and slowing capability while engine 18 is turned on or off. Electric machine 14 acting as a generator can recover energy that may normally be lost as heat in a friction braking system. Electric machine 14 may reduce vehicle emissions by allowing engine 18 to operate at more efficient speeds and allowing EV 12 to be operated in electric mode with engine 18 off under certain conditions.

A traction battery 24 (“battery) stores energy that can be used by electric machine 14 for propelling EV 12. Battery 24 typically provides a high-voltage (HV) direct current (DC) output. Battery 24 is electrically connected to a power electronics module 26. Power electronics module 26 is electrically connected to electric machine 14 and provides the ability to bi-directionally transfer energy between battery 24 and the electric machine 14. For example, battery 24 may provide a DC voltage while electric machine 14 may require a three-phase alternating current (AC) voltage to function. Power electronics module 26 may convert the DC voltage to a three-phase AC voltage to operate electric machine 14. In a regenerative mode, power electronics module 26 may convert three-phase AC voltage from electric machine 14 acting as a generator to DC voltage compatible with battery 24.

Battery 24 is rechargeable by an external power source 36 (e.g., the grid). Electric vehicle supply equipment (EVSE) 38 is connected to external power source 36. EVSE 38 provides circuitry and controls to control and manage the transfer of energy between external power source 36 and EV 12. External power source 36 may provide DC or AC electric power to EVSE 38. EVSE 38 may have a charge connector 40 for plugging into a charge port 34 of EV 12. Charge port 34 may be any type of port configured to transfer power from EVSE 38 to EV 12. A power conversion module 32 of EV 12 may 12 may condition power supplied from EVSE 38 to provide the proper voltage and current levels to battery 24. Power conversion module 32 may interface with EVSE 38 to coordinate the delivery of power to battery 24. Alternatively, various components described as being electrically connected may transfer power using a wireless inductive coupling.

Wheel brakes 44 are provided for slowing and preventing motion of EV 12. Wheel brakes 44 are part of a brake system 50. Brake system 50 may include a controller to monitor and control wheel brakes 44 to achieve desired operation.

The various components discussed may have one or more associated controllers to control and monitor the operation of the components. The controllers can be microprocessor-based devices. The controllers may communicate via a serial bus (e.g., Controller Area Network (CAN)) or via discrete conductors. For example, a system controller 48 (i.e., a vehicle controller) is present to coordinate the operation of the various components.

As described, EV 12 is in this example is a PHEV having engine 18 and battery 24. In other embodiments, EV 12 is a battery electric vehicle (BEV). In a BEV configuration, EV 12 does not include an engine.

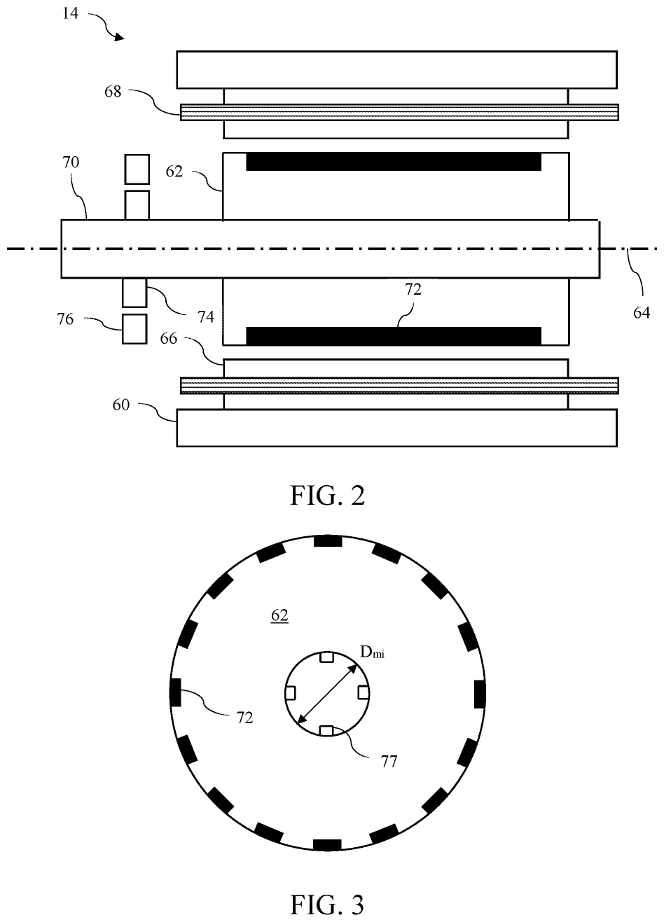

FIG. 2 is a schematic cross-section of a synchronous electric traction motor, such as electric machine 14 of FIG. 1. Motor 14 includes a stator 60 and a rotor 62. Stator 60 is fixed with respect to the vehicle. Rotor 62 is supported for rotation about axis 64. Stator 60 includes a number of inward projections 66 called stator poles. An electrical conductor, called a winding 68, is wrapped around each of the stator poles. Rotor 62 is fixed for rotation with rotor shaft 70. A set of permanent magnets 72 are fixed to a surface of the rotor at intervals around the circumference.

In operation, power electronics module 26 adjust an alternating current (AC) in the windings to create magnetic field in the stator poles which interact with the magnetic field of the permanent magnets to generate torque. As the rotor rotates, the winding current is adjusted to maintain the desired relationship between the magnetic fields. The torque magnitude depends both on the magnitude of the winding current and on the phase relationship. To correctly adjust the phase of the winding current, the power electronics module 26 needs accurate information about the present rotational position of the rotor with respect to the stator. This information may be provided by a resolver. The resolver includes a resolver rotor 74 which rotates with the rotor and a sensor 76 which is fixed with respect to the stator.

FIG. 3 is an end view of the rotor body 62. The bore of the rotor body has a maximum internal diameter Dₘᵢ. One or more keys 77 extend inwardly into the bore. As will be discussed below, these keys establish a rotational position relationship between the permanent magnets 72 and the shaft 70.

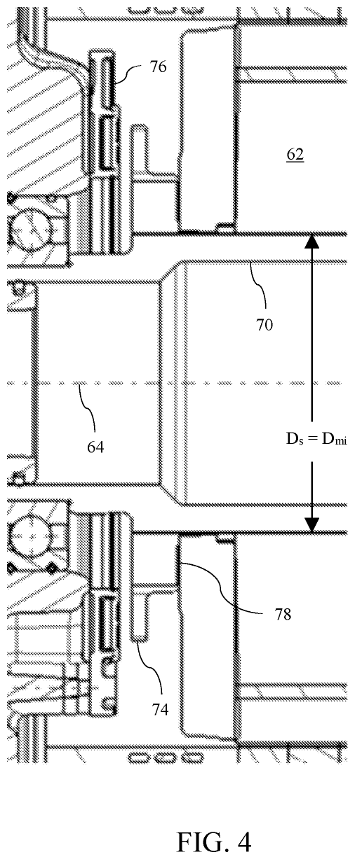

FIG. 4 is a cross sectional view of one end of the motor that includes the resolver. Since the motor is predominantly axi-symetric, many features appear both above and below centerline 64 although the reference numeral may only appear in one of those locations. Hollow shaft 70 includes a flange 78 near one end. Resolver rotor 74 is formed from a portion of the flange 78. The resolver sensor 76 is attached to the fixed structure. The rotor body 62 abuts the flange 78. The flange 78 is used to axially locate the rotor body 62. The shaft 70 has a maximum diameter Dₛ in the section of the shaft to the right of the flange. The rotor body has a minimum internal diameter Dₘᵢ, which is no less than the shaft maximum diameter Dₛ. In FIG. 3, these two diameters are equal. The phrase “no less” in this context encompasses a situation where the inner diameter of the rotor body is sufficiently large that it can slide over the shaft, even if there is a slight interference fit.

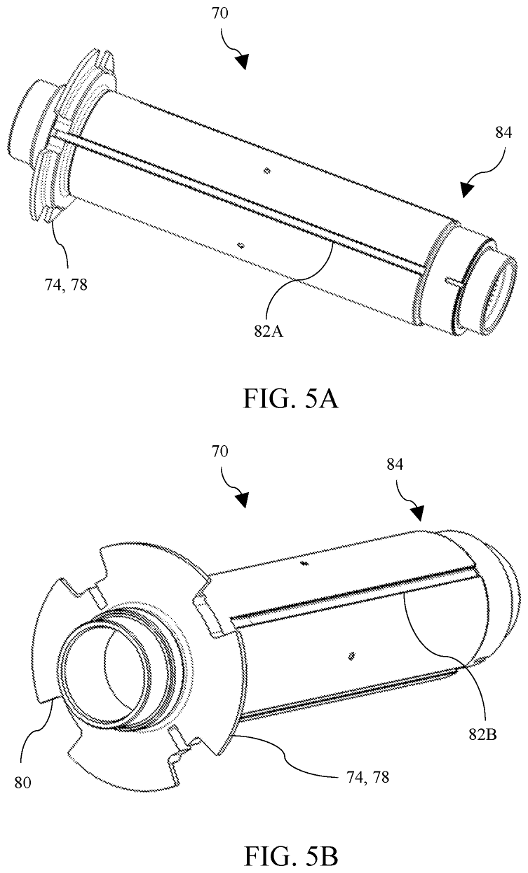

FIGS. 5A and 5B are pictorial views of shaft 70. Flange 78 may be formed integrally with the shaft 70, such as by forging or additive manufacturing. Flange 78 is adapted to function as the resolver rotor 74 by forming a series of radial cutouts 80 around a perimeter of the flange. Sensor 76 detects whether a position on the sensor is adjacent to a cutout or not and sends a signal to a controller from which the controller can determine the rotational position of the shaft 70. The sensor may detect the cutouts at several circumferential positions.

Axial keyways, such as 82A and 82B, ensure that the rotor body is attached to the shaft at a predetermined circumferential position relative to the cutouts. The rotor body 62 includes inward projecting keys at predefined circumferential positions relative to the permanent magnets. These keys fit into these keyways such that the relative position of the cutouts and the permanent magnets are predetermined. Therefore, the signal from the sensor indicates the rotational positions of the permanent magnets. A keyway may extend axially through the flange 78 as illustrated by keyway 82A. Alternatively, a keyway may end at an axial position past the flange as illustrated by keyway 82B.

An end section 84 of shaft 70 is opposite the flange. This end section has a maximum diameter no greater than the minimum internal diameter of rotor body 62. (The minimum diameter of the rotor body is measured at a circumferential location that does not include a key.) This relationship allows the rotor body to slide over the shaft 70 during assembly. The end section includes the end of the shaft and extends far enough to axially overlap the rotor body when the motor is assembled.

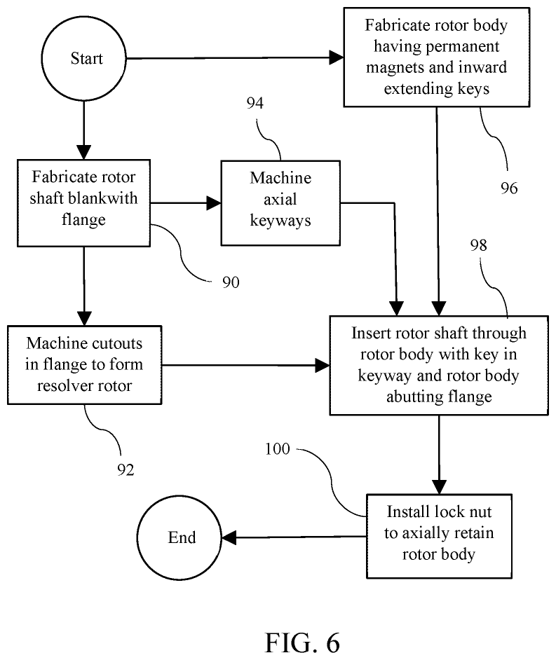

FIG. 6 is a flow chart for a method of assembling a rotor. At 90, a blank for rotor shaft 70 is fabricated. For example, the blank could be fabricated by forging or by using a powdered metal or additive manufacturing process. The blank includes flange 78 which may be integrally formed. An end section opposite the flange has a maximum outer diameter of Dₛ. At 92, cutouts 80 are formed in the flange, such as by machining. At 94, axial keyways are formed in the shaft. The keyways may extend through the flange like keyway 82A or may end prior to the flange like keyway 82B. At 96, the rotor body 62 is fabricated. The rotor body includes a number of permanent magnets around its periphery. The rotor body has a central opening with a diameter of Dₘᵢ. The rotor body has at least key extending inwardly into the central opening and dimensioned to fit into the keyway. At 98, the shaft is inserted into the central opening of the rotor body such that the rotor body axially abuts the flange. The key fits into a keyway to establish a predetermined angular relationship between the permanent magnets and the flange cutouts. Finally, at 100, a lock nut is affixed to the end section of the shaft to axially retain the rotor body.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A traction motor comprising:
a stator;
a shaft supported for rotation with respect to the stator, the shaft having a fixed flange defining radial cutouts, the shaft having an end section with a maximum diameter;
a rotor body rotationally fixed to the shaft axially abutting the flange at a first end and axially overlapping the end section at a second end, the rotor body having a set of permanent magnets at predefined circumferential positions with respect to the cutouts, the rotor body having an inside diameter no less than the maximum diameter of the end section; and
a sensor fixed to the stator and configured to produce a signal indicating a rotational position of the shaft with respect to the stator based on the position of the cutouts.

2. The traction motor of claim 1 wherein the shaft further defines an axial keyway and the rotor body includes a mating inwardly extending key to establish a predetermined relative rotation position between the shaft and the rotor body.

3. The traction motor of claim 2 wherein the axial keyway extends through the flange.

4. The traction motor of claim 2 wherein the axial keyway does not extend through the flange.

5. The traction motor of claim 1 wherein the flange is integrally formed with the shaft.

6. A rotor assembly comprising:
a shaft having a fixed flange, the flange defining radial cutouts configured to interact with a non-rotating resolver sensor such that the resolver sensor produces a signal indicating a rotational position, the shaft further having an end section with a maximum diameter; and
a rotor body rotationally fixed to the shaft axially abutting the flange at a first end and overlapping the end section at a second end, the rotor body having an inside diameter no less than the maximum diameter of the end section.

7. The rotor of claim 6 wherein a set of permanent magnets are affixed to the rotor body.

8. The rotor of claim 6 wherein the shaft further defines an axial keyway and the rotor body includes a mating inwardly extending key to establish a predetermined relative rotation position between the shaft and the rotor body.

9. The rotor of claim 8 wherein the axial keyway extends through the flange.

10. The rotor of claim 8 wherein the axial keyway does not extend through the flange.

11. The rotor of claim 6 wherein the flange is integrally formed with the shaft.

12. A method of assembling a motor, comprising:
forming a plurality of cutouts in a flange of a rotor shaft, the cutouts configured to interact with a non-rotating resolver sensor such that the resolver sensor produces a signal indicating a rotational position of the shaft; and
inserting a rotor body onto the shaft such that the rotor body axially abuts the flange.

13. The method of claim 12 further comprising forming an axial keyway on the shaft.

14. The method of claim 13 wherein the axial keyway extends through the flange.

15. The method of claim 13 wherein the axial keyway does not extend through the flange.

16. The method of claim 12 further comprising attaching a lock nut to the shaft axially abutting the rotor body on an opposite end of the rotor body from the flange.
